(19) United States
(12) Patent Application Publication
(10) Pub. No.: US 2013/0043391 A1
(43) Pub. Date: Feb. 21, 2013

(54) Non-Dispersive Infrared (NDIR) Dual Trace Gas Analyzer and Method for Determining a Concentration of a Measurement Gas Component in a Gas Mixture by the Gas Analyzer

(71) Applicants: Ralf Bitter, Karlsruhe (DE); Camiel Heffels, Stutensee-buechig (DE); Thomas Hörner, Karlsruhe (DE)

(72) Inventors: Ralf Bitter, Karlsruhe (DE); Camiel Heffels, Stutensee-buechig (DE); Thomas Hörner, Karlsruhe (DE)

(73) Assignee: Siemens Aktiengesellschaft, Muenchen (DE)

(21) Appl. No.: 13/518,552

(22) PCT Filed: Dec. 14, 2010
(86) PCT No.: PCT/EP2010/069598

§ 371 Date: Sep. 26, 2012

(30) Foreign Application Priority Data
Dec. 22, 2009 (DE) 10 2009 059 962.2

(51) Int. Cl. G01N 21/61

(52) U.S. Cl. 250/341.1; 250/345

(57) ABSTRACT

A modulator wheel of a gas analyzer which contains an opening in the shadowing part thereof, where the opening generates in the measurement signal of the gas analyzer, in addition to a signal component at a modulation frequency generated by alternating shadowing and passing-through of the radiation, a further signal component having twice the modulation frequency that is used for detecting changes to the infrared radiation source or detector arrangement due to contamination, aging, or temperature, and compensating for the effects thereof on the measurement result.

### CROSS-REFERENCE TO RELATED APPLICATIONS

This is a U.S. national stage of application No. PCT/EP2010/069598 filed 14 Dec. 2010. Priority is claimed on German Application No. 10 2009 059 962.2 filed 22 Dec. 2009, the content of which is incorporated herein by reference in its entirety.

### BACKGROUND OF THE INVENTION

1. Field of the Invention

The invention relates to a method for determining a concentration of a measurement gas component in a gas mixture by means of a non-dispersive infrared (NDIR) dual trace gas analyzer and to an NDIR dual trace gas analyzer.

2. Description of the Related Art

WO 2008/135416 A1 discloses a conventional method and gas analyzer which are used to determine the concentration of a measurement gas component in a gas mixture. To this end, infrared radiation generated by an infrared radiation source is passed alternately through a measurement cuvette holding the gas mixture and through a reference cuvette containing a reference gas. The radiation emerging from the two cuvettes is detected by a detector arrangement, where a measurement signal is generated and subsequently evaluated in an evaluation unit. Conventional detector arrangements contain one or more optopneumatic detectors in the form of monolayer or double layer receivers. The switching of the radiation between the measurement cuvette and the reference cuvette is performed by a modulator, which is conventionally a vane wheel or shutter wheel. When the two cuvettes are filled with the same gas for zero calibration, i.e., a neutral gas such as nitrogen or air, and the gas analyzer is optically balanced, the same radiation intensity always reaches the detector arrangement so that no measurement signal (alternating signal) is generated. If the measurement cuvette is filled with the gas mixture to be studied, then a preliminary absorption occurs there, which is dependent on the concentration of the measurement gas component contained therein and secondary gases which may be present. Consequently, chronologically successively different radiation intensities reach the detector arrangement from the measurement cuvette and the reference cuvette in time with the modulation, which as a measurement signal generates an alternating signal at the frequency of the modulation and with a magnitude dependent on the difference between the radiation intensities.

The radiation intensity striking the detector arrangement, however, is dependent not only on the gas-specific absorption but also on other factors that influence the intensity of the infrared radiation. Such influencing factors, such as modifications of the infrared radiation source or the detector arrangement due to contamination, aging or temperature, cannot readily be detected and lead to vitiations of the measurement result.

For this reason, it is necessary to calibrate the gas analyzer at regular intervals, in which case, for example, the measurement cuvette is successively filled with neutral gas and final gas, i.e., known concentrations of the measurement gas.

In order to calibrate an NDIR dual trace gas analyzer, it is known from DE 195 47 787 C1 to fill the measurement cuvette with a neutral gas and to interrupt the radiation through the reference cuvette by means of a shutter. A single trace functionality of the gas analyzer is thereby obtained, which permits referencing, e.g., of the intensity of the infrared radiation source, without having to fill the measurement cuvette with a calibration or standardization gas.

In the case of the conventional NDIR dual trace gas analyzer described in EP 1 640 708 A1, which was mentioned in the introduction, during the modulation period at least two dark phases are generated, in which the radiation both through the measurement cuvette and through the reference cuvette is interrupted. In this way, the fundamental oscillation of the measurement signal is modulated up with a harmonic oscillation having double the frequency. After performing a Fourier analysis of the measurement signal, measurement quantities normalized by the first two Fourier components are determined and the concentration of the measurement gas component is determined by coordinate transformation of the normalized measurement quantities.

In the case of the conventional NDIR dual trace gas analyzer described in the aforementioned WO 2008/135416 A1, the detector arrangement comprises at least two monolayer receivers, both of which deliver a measurement signal and which lie in series in the beam path of the gas analyzer. The first monolayer receiver contains, for example, the measurement gas component, and the at least one subsequent monolayer receiver contains a secondary gas. The evaluation unit contains an n-dimensional calibration matrix, corresponding to the number n of monolayer receivers, in which measurement signal values obtained with different known concentrations of the measurement gas component in the presence of different known secondary gas concentrations are stored as an n-tuple. When measuring unknown concentrations of the measurement gas component in the presence of unknown secondary gas concentrations, the concentration of the measurement gas component is ascertained by comparison of the n-tuple of signal values thereby obtained with the n-tuples of signal values stored in the calibration matrix. Furthermore, for example, when the secondary gas concentrations are kept constant the intensity of the radiation generated may be varied to ascertain the influence on the measurement result of transmission changes due to aging of the infrared radiator or contaminations of the measurement cuvette.

### SUMMARY OF THE INVENTION

It is an object of the invention to simplify the detection and compensation for error influences, such as modifications of the infrared radiation source or the detector arrangement due to contamination, aging or temperature.

This and other objects and advantages are achieved in accordance with the invention by a method and NDIR dual trace gas analyzer in which an additional fraction of infrared radiation is transmitted in one section of a shielding phase, so that during this section the sum of infrared radiation simultaneously shielded and transmitted in the two beam paths is greater than in the other sections of the shielding phase, a signal component at double the modulation frequency is ascertained from a measurement signal, and the signal component is used to calibrate the gas analyzer with respect to an influencing of the intensity of the infrared radiation and/or acknowledgement of such influencing, where the influencing occurs outside of a measurement cuvette and a reference cuvette.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

For further explanation of the invention, reference will be made below to the figures of the drawing; in detail, respectively in the form of an exemplary embodiment:

FIG. 1 shows an NDIR dual trace gas analyzer comprising a detector arrangement consisting of two successively placed monolayer receivers and delivering two measurement signals in accordance with the invention;

FIGS. 2 to 4 respectively show three different arrangements of the modulation wheel, measurement cuvette and reference cuvette of the gas analyzer in plan view in accordance with the invention;

FIG. 5 shows exemplary graphical plots of measurement signals generated by the detector arrangement and the signal components thereof at the basic modulation frequency and double the modulation frequency in accordance with the invention;

FIG. 6 shows exemplary graphical plots of signal components obtained during calibration of the gas analyzer at the basic modulation frequency and double the modulation frequency in accordance with the invention;

FIG. 7 shows a result matrix in which, separately for the signal components at the basic modulation frequency and double the modulation frequency, measurement signal values obtained for different known concentrations of the measurement gas component, in the presence of different known secondary gas concentrations, are stored as value pairs; and

FIG. 8 is a flowchart of the method in accordance with an embodiment of the invention.

### DETAILED DESCRIPTION OF THE PREFERRED EMBODIMENTS

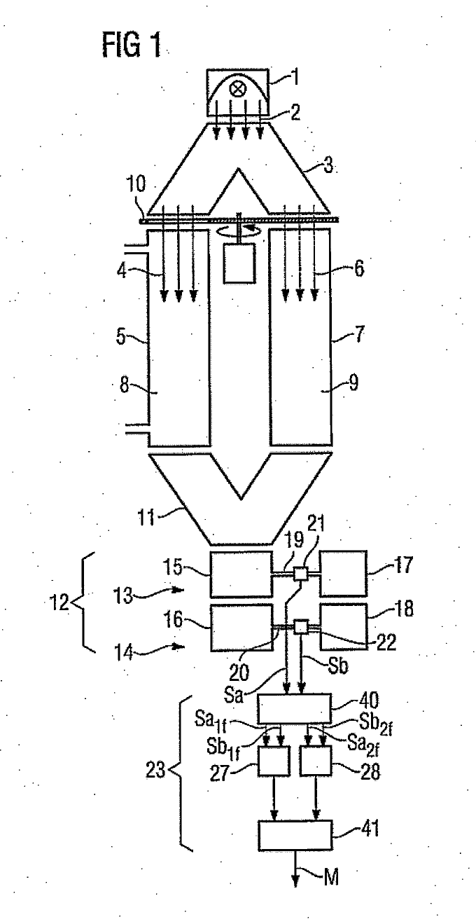

FIG. 1 shows an NDIR dual trace gas analyzer in which the infrared radiation 2 generated by an infrared radiation source 1 is divided by a beam splitter 3 (i.e., a hose chamber) between a measurement beam path 4 through a measurement cuvette 5 and a comparison beam path 6 through a reference cuvette 7. A gas mixture 8 comprising a measurement gas component, the concentration of which is to be determined, can be introduced into the measurement cuvette 5. The reference cuvette 7 is filled with a reference gas 9. By means of a modulator 10 arranged between the beam splitter 3 and the cuvettes 5 and 7 in the form of a rotating shutter wheel or vane wheel, the radiation 2 through the measurement cuvette 5 and the reference cuvette 7 is alternately let through and blocked, so that the two cuvettes 5 and 7 are alternately shone through and shielded. The radiation alternately emerging from the measurement cuvette 5 and the reference cuvette 7 is conveyed by a radiation collector 11 into a detector arrangement 12 which, in the present exemplary embodiment, consists of a first monolayer receiver 13 and a subsequently arranged further monolayer receiver 14. Each of the two monolayer receivers 13, 14 comprises an active detector chamber 15, 16, respectively, receiving the radiation 2 emerging from the cuvettes 5 and 7, and, arranged outside the radiation 2, a passive compensation chamber 17, 18, respectively, which are connected to one another by a connecting line 19, 20, respectively, having a pressure- or flow-sensitive sensor 21, 22, respectively, arranged therein. The sensors 21 and 22 generate measurement signals Sa and Sb from which the concentration of the measurement gas component in the gas mixture 8 is ascertained as a measurement result M in an evaluation unit 23.

Besides the main signal component generated by the absorption of radiation in its active detector chamber 16, the measurement signal Sb of the second monolayer receiver 14 also contains a smaller signal component from the first monolayer receiver 13. The measurement signals Sa and Sb of the two monolayer receivers 13 and 14 therefore form a 2-dimensional result matrix. If the detector arrangement 12 consists of n (n≧1) monolayer receivers lying in series, n measurement signals Sa, Sb will be obtained which form an n-dimensional result matrix. If the first monolayer receiver 13 contains the measurement gas component and if the subsequent n-1 monolayer receivers are filled with different secondary gases, then the concentration of the measurement gas component can be ascertained even in the presence of these secondary gases in different concentrations.

FIG. 2 shows a first example of the modulator wheel 10, which comprises a shielding part 24 in the form of a semicircular sector and whose rotation axis 25 is arranged between the measurement cuvette 5 and the reference cuvette 7. During each revolution of the modulator wheel 10, the infrared radiation 2 is blocked once and transmitted once through the two cuvettes 5, 7. Here, when the radiation 2 is being transmitted through one cuvette, for example 5, the other cuvette 7 is shielded and vice versa. The effect achieved by the symmetrical arrangement is firstly that, to the same extent as radiation 2 is transmitted through one cuvette, for example 5, the other cuvette 7 is shielded, so that the sum of transmitted and simultaneously shielded radiation 2 remains constant during the rotation of the modulator wheel 10. In accordance with the invention, this symmetry is broken by an opening 26 in the shielding part 24, which transmits an additional fraction of the radiation 2 in a section of the shielding phase, so that during this section the sum of transmitted and simultaneously shielded radiation 2 is greater than in the other sections of the shielding phase.

FIG. 3 shows a second example of the modulator wheel 10, which differs from the modulator wheel shown in FIG. 2 in that the shielding part 24 is divided into three vanes 24a, 24b, 24c, where each in the form of a one-sixth sector of a circle, each of the vanes 24a, 24b, 24c respectively contain an opening 26. The processes described for FIG. 2 therefore occur three times during each revolution of the modulator wheel 10.

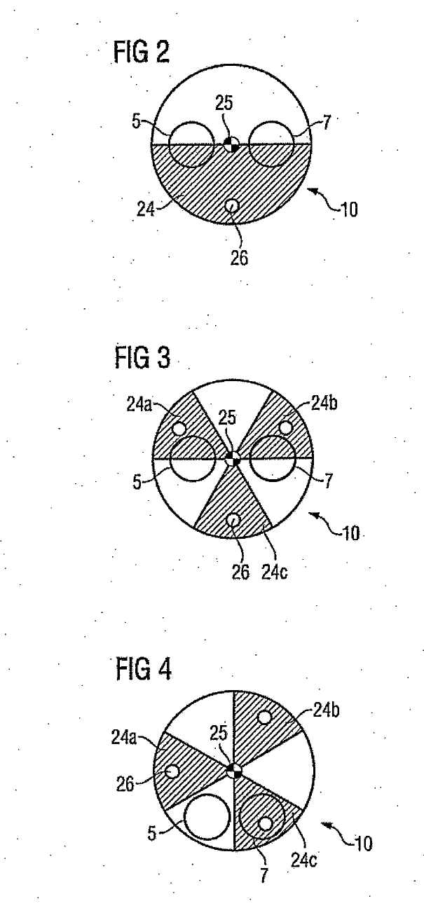

FIG. 4 shows a third example of the modulator wheel 10, which differs from the modulator wheel shown in FIG. 3 in that the measurement cuvette 5 and the reference cuvette 7 are arranged together on one side of the rotation axis 25, which provides a particularly compact design. In other regards, the behavior and the functionality are as in the exemplary embodiment depicted in FIG. 3.

As an alternative to the embodiments shown, the modulator wheel 10 may also be formed as a shutter wheel and the opening 26 may, for example, be formed in a slit shape.

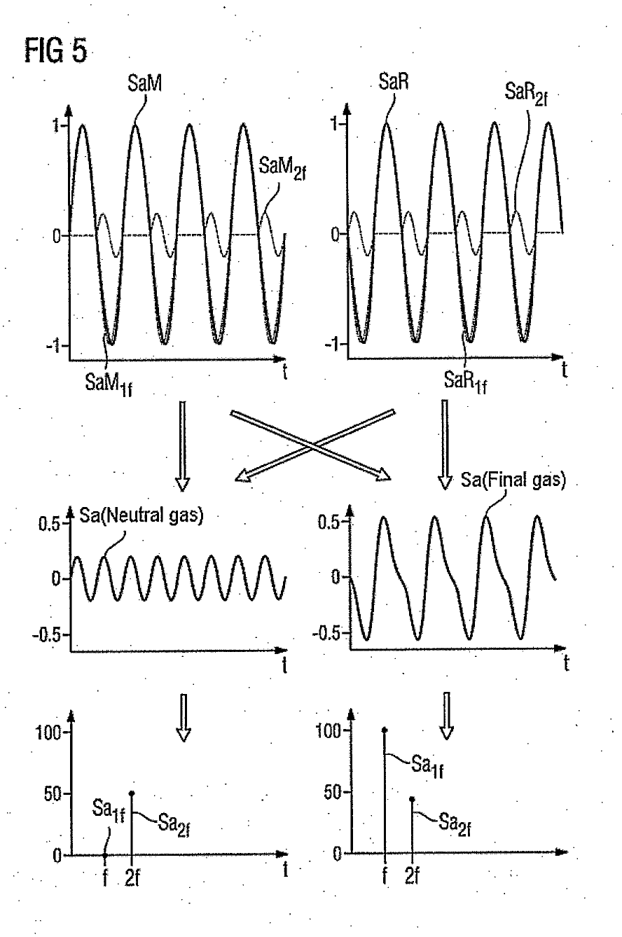

FIG. 5 shows an exemplary measurement signal Sa generated by the first monolayer receiver 13 of the detector arrangement 12, where a signal component SaM resulting from the radiation through the measurement cuvette 5 (measurement beam path 4) is represented at the top left and a signal component SaR resulting from the radiation through the reference cuvette 7 (comparison beam path 6) is represented at the top right. The two signal components SaM and SaR are composed of a signal component SaM1f, SaM1f, respectively, generated by the alternate shielding and transmission of the radiation 2 at the modulation frequency f, and a signal component SaM2f, SaR2f, respectively, generated by the opening 26 in the shielding part 24 of the modulator wheel 10 at double the modulation frequency 2f. The following therefore applies for the measurement signal: Sa=SaM+SaR=(SaM1f+SaM2f)+(SaR1f+SaR2f).

At the middle left, FIG. 5 shows the measurement signal Sa obtained during the calibration of the gas analyzer with neutral gas and underneath (bottom left) its frequency components. In this case, the measurement cuvette 5 is filled with the reference gas or another gas that is not active in the infrared (neutral gas). If the gas analyzer is optically balanced, then the signal component Sa1f=SaM1f+SaR1f generated by the alternate shielding and transmission of the radiation 2, at the modulation frequency f is equal to zero, i.e., Sa=Sa2f. Unbalancing of the gas analyzer between the measurement beam path 4 and the comparison beam path 6 can therefore be detected by the signal component Sa1f.

The signal component Sa2f=SaM2f+SaR2f generated by the opening 26 in the shielding part 24 of the modulator wheel 10 at double the modulation frequency 2f is a measure of the intensity of the detected infrared radiation 2 and therefore makes it possible to detect intensity variations resulting from modifications of the infrared radiation source 1 or the detector arrangement 12 due to contamination, aging or temperature.

At the middle right, FIG. 5 shows the measurement signal Sa obtained during the calibration of the gas analyzer with final gas (final value gas) and underneath (bottom right) its frequency components. In this case, measurement cuvette 5 is filled with the final gas, i.e., the measurement gas component, in a known (generally maximum) concentration. Owing to the preliminary absorption by the final gas in the measurement cuvette 5, chronologically successively different radiation intensities reach the detector arrangement 12 from the measurement cuvette 5 and the reference cuvette 7 according to the modulation by the modulation wheel 10, so that the first monolayer receiver 13 generates a measurement signal Sa having a signal component Sa1f at the modulation frequency f and a magnitude dependent on the difference between the radiation intensities. The magnitude of this signal component Sa1f is also dependent on the intensity of the infrared radiation 2 generated and possibly interfered with by modifications of the infrared radiation source 1 or the detector arrangement 12 due to contamination, aging or temperature. A further signal component Sa2f generated by the opening 26 in the shielding part 24 of the modulator wheel 10 at double the modulation frequency 2f is dependent primarily on the intensity of the infrared radiation 2 and to a lesser extent on the preliminary absorption by the final gas in the measurement cuvette 5.

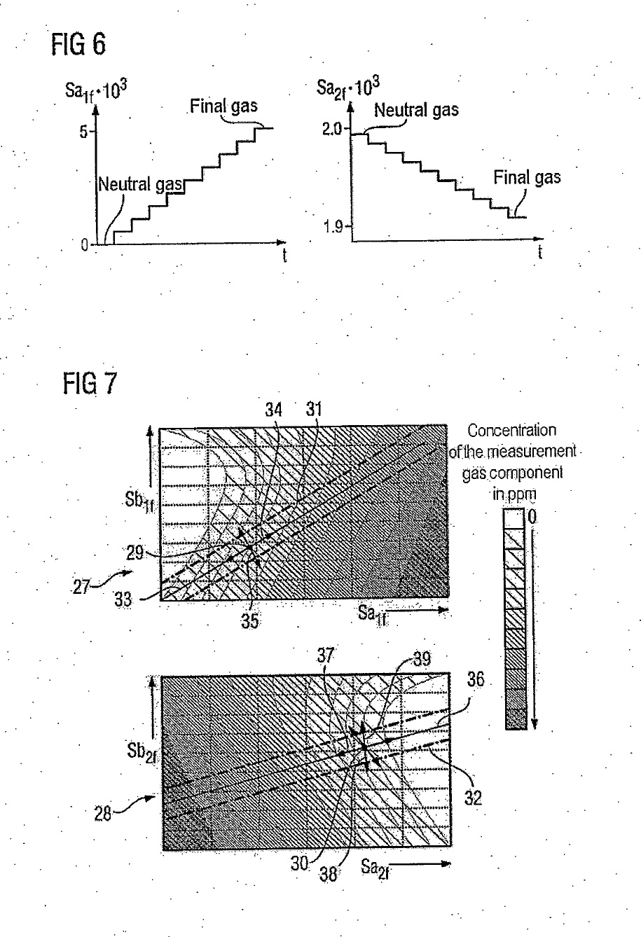

FIG. 6 shows on the left an exemplary signal component Sa1f at the frequency f obtained in 10 calibration stages from neutral gas to final gas in the calibration of the gas analyzer and on the right the signal component Sa2f at the frequency 2f. The signal component Sa1f has the typical measurement signal profile for a dual trace gas analyzer, which starts at or close to zero and increases with an increasing concentration of the measurement gas component. The signal component Sa2f, on the other hand, has the typical measurement signal profile for a single trace gas analyzer, which starts at a maximum value for neutral gas and decreases with an increasing concentration of the measurement gas component. Referencing to the intensity of the infrared radiation 2 generated, and therefore a correction of the increase in the Sa1f signal component, is therefore possible with the signal component Sa2f even with neutral gas. That is, when the Sa2f signal component changes between two calibration processes with neutral gas, the rise in the Sa1f is corrected accordingly. The Sa1f signal component itself may be used for adjustment of misbalancing between the measurement cuvette 5 and the reference cuvette 7. In the case of an NDIR dual trace gas analyzer having only one monolayer receiver 13, two-point calibration with neutral gas is thus possible.

If, as shown in FIG. 1, the gas analyzer comprises two monolayer receivers 13 and 14, then the measurement signals Sa and Sb of the two monolayer receivers 13 and 14 form a two-dimensional result matrix.

Shown in the upper part of FIG. 7 is such a result matrix 27 for the signal components Sa1f and Sb1f at the frequency f, and in the lower part of the figure a result matrix 28 for the signal components Sa2f and Sb2f at the frequency 2f. In the result matrices 27, 28 (separately for the signal components Sa1f and Sb1f at the basic modulation frequency and Sa2f and Sb2f at double the modulation frequency) signal component values obtained for different known concentrations of the measurement gas component in the presence of different known secondary gas concentrations are stored as value pairs 29 (Sa1f, Sb1f) and 30 (Sa2f, Sb2f), respectively. In this case, intermediate values may be formed by interpolation of recorded or known sample values, so that a reduced measurement range is sufficient for compilation of the result matrices 27, 28.

For real measurement situations, the secondary gases and the variation ranges to be expected for their concentrations are known, so that a corridor 31, 32 can respectively be established in the result matrices 27, 28, inside which the value pairs 29, 30, respectively, dependent on the concentrations of the measurement gas component and the known secondary gases lie in standard cases. In the event of variable concentrations of the measurement gas component, the value pairs 29 in the result matrix 27 move along a characteristic line 33 in the direction denoted by 34, and in the event of the different concentrations to be expected for the secondary gases they deviate from the characteristic line 33 in the direction denoted by 35. Thus, if the value pair 29 moves in one direction during successive measurements, which besides a component in the direction 34 also comprises a component in the direction 35, the secondary gas influence on the measurement result can be compensated for by ascertaining the direction component 35 and computationally moving the value pair 29 back by the amount of this component 35. With the value pair corrected in this way, the result matrix 27 thus gives the correct value of the concentration of the measurement gas component.

Variations in the power of the infrared radiator 1, or contaminations of the measurement cuvette 5, cannot be discriminated in the result matrix 27 from changes in the concentration of the measurement gas component, and lead to a variation of the value pairs 29 along the characteristic line 33.

In the result matrix 28, with variable concentrations of the measurement gas component, the value pairs 30 move along a characteristic line 36 in the direction denoted by 37, and in the event of the different concentrations to be expected for the secondary gases they deviate from the characteristic line 36 in the direction denoted by 38. In addition, however, variations in the performance of the infrared radiator 1 or contamination of the measurement cuvette 5 lead to a movement of the value pairs 30 deviating from the characteristic line 36 in the direction denoted by 39. Intensity variations of the infrared radiation 2 thus have different direction vectors in the two result matrices 27, 28, and therefore can be compensated for in relation to the measurement result. Regular calibrations of the gas analyzer can therefore be obviated.

In order to ascertain the signal components Sa1f, Sb1f, Sa2f and Sb2f from the measurement signals Sa and Sb, the evaluation unit 23 shown in FIG. 1 contains a frequency discriminator 40, after which the two result matrices 27 and 28 are located. The evaluation of the value pairs 29, 30 to give the measurement result M and the compensation thereof take place in the unit denoted by 41.

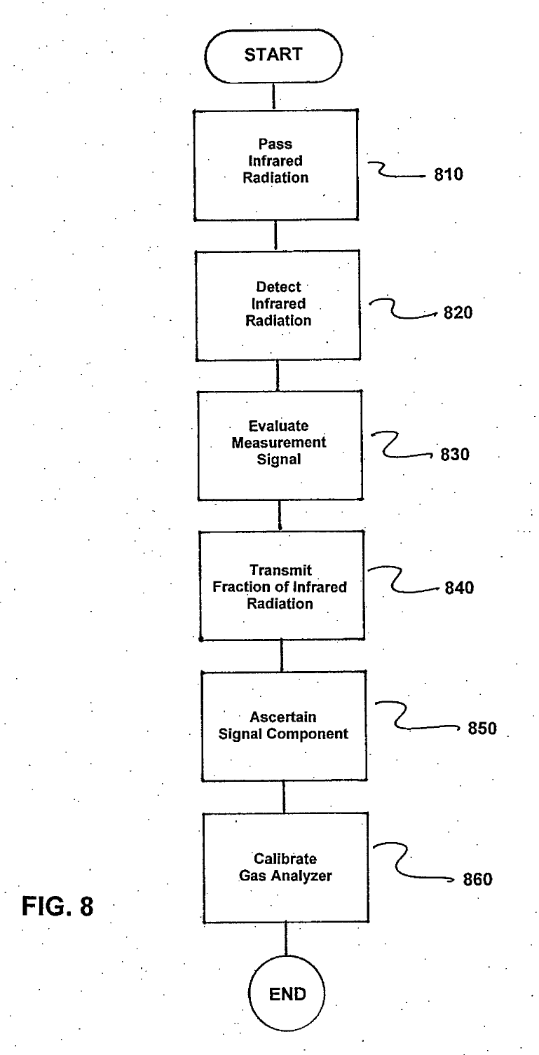

FIG. 8 is a flow chart of a method for determining a concentration of a measurement gas component in a gas mixture by a non-dispersive infrared (NDIR) dual trace gas analyzer. The method comprises passing infrared radiation in a measurement beam path through a measurement cuvette holding the gas mixture and in a comparison beam path through a reference cuvette containing a reference gas, as indicated in step 810.

The infrared radiation is detected and a measurement signal is generated while alternately shielding and transmitting the infrared radiation in the measurement and comparison beam paths with a predetermined modulation frequency such that a sum of simultaneously shielded and transmitted infrared radiation is the same, as indicated in step 820. The measurement signal is now evaluated to determine a concentration of the measurement gas component, as indicated in step 830.

An additional fraction of the infrared radiation in one section of the shielding phase is transmitted, so that during this section the sum of infrared radiation simultaneously shielded and transmitted in the two measurement and comparison beam paths is greater than in other sections of a shielding phase, as indicated in step 840. Next, a signal component at double a modulation frequency from the measurement signal is ascertained, as indicated in step 850. The gas analyzer is then calibrated based on the signal component with respect to an influencing of at least one of an intensity of the infrared radiation and an acknowledgement of such influencing, as indicated in step 860. Here, the influencing occurs outside the measurement cuvette and the reference cuvette.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-8. (canceled)

9. A method for determining a concentration of a measurement gas component in a gas mixture by a non-dispersive infrared (NDIR) dual trace gas analyzer, comprising:
passing infrared radiation in a measurement beam path through a measurement cuvette holding the gas mixture and in a comparison beam path through a reference cuvette containing a reference gas;
detecting the infrared radiation and generating a measurement signal while alternately shielding and transmitting the infrared radiation in the measurement and comparison beam paths with a predetermined modulation frequency such that a sum of simultaneously shielded and transmitted infrared radiation is the same;
evaluating the measurement signal to determine a concentration of the measurement gas component;
transmitting an additional fraction of the infrared radiation in one section of the shielding phase, so that during this section the sum of infrared radiation simultaneously shielded and transmitted in the two measurement and comparison beam paths is greater than in other sections of a shielding phase;
ascertaining a signal component at double a modulation frequency from the measurement signal; and
calibrating the gas analyzer based on the signal component with respect to an influencing of at least one of an intensity of the infrared radiation and an acknowledgement of such influencing, said influencing occurring outside the measurement cuvette and the reference cuvette.

10. The method as claimed in claim 9, wherein the calibration is performed with neutral gas in the measurement cuvette.

11. The method as claimed in claim 9, further comprising:
ascertaining a further signal component at the modulation frequency from the measurement signal; and
detecting unbalancing of the gas analyzer between the measurement beam path and the comparison beam path with the further signal component when filling the measurement cuvette with neutral gas.

12. The method as claimed in claim 10, further comprising:
ascertaining a further signal component at the modulation frequency from the measurement signal; and
detecting unbalancing of the gas analyzer between the measurement beam path and the comparison beam path with the further signal component when filling the measurement cuvette with neutral gas.

13. The method as claimed in claim 11, wherein the concentration of the measurement gas component is determined from the further signal component.

14. The method as claimed in claim 13, further comprising:
compiling a characteristic line from values of the further signal component obtained with different known concentrations of the measurement gas component, and correcting a slope of the characteristic line when calibrating the gas analyzer with neutral gas with the value thereby obtained for the signal component.

15. The method as claimed in claim 9, wherein said detecting comprises detecting the infrared radiation emerging from the measurement cuvette and the reference cuvette by two monolayer receivers connected in series; and said ascertaining comprises ascertaining signal components at double the modulation frequency and the further signal components at the basic modulation frequency, respectively, from the measurement signals of the two monolayer receivers; and
wherein the method further comprises processing the signal components further in a first two-dimensional calibration matrix and processing the further signal components in a second two-dimensional calibration matrix with evaluation of the movement directions of the value pairs in the result matrices.

16. A non-dispersive infrared (NDIR) dual trace gas analyzer for determining a concentration of a measurement gas component in a gas mixture, comprising:
an infrared radiation source for generating infrared radiation;
a measurement cuvette holding the gas mixture and through which the infrared radiation is transmittable in a measurement beam path;
a reference cuvette containing a reference gas and through which the infrared radiation is transmittable in a comparison beam path;
a modulator wheel comprising a shielding part which alternately shields and transmits the infrared radiation in the measurement and comparison beam paths with a predetermined modulation frequency such that a sum of simultaneously shielded and transmitted infrared radiation is the same;
a detector arrangement configured to detect the radiation emerging from the measurement cuvette and the reference cuvette, and generate a measurement signal; and
an evaluation unit configured to determine the concentration of the measurement gas component from the measurement signal;
wherein the modulator wheel contains an opening in the shielding part, so that an additional fraction of the infrared radiation is transmitted in a section of the shielding phase and, during this section, the sum of infrared radiation simultaneously shielded and transmitted in the measurement and comparison beam paths is greater than in other sections of the shielding phase;
wherein the evaluation unit contains a frequency discriminator configured to ascertain a signal component at double the modulation frequency from the measurement signal.

17. The non-dispersive infrared dual trace gas analyzer as claimed in claim 16, wherein the frequency discriminator ascertains a further signal component at the modulation frequency from the measurement signal.
